(19) United States
(12) Patent Application Publication
(10) Pub. No.: US 2003/0159060 A1
(43) Pub. Date: Aug. 21, 2003

(54) System and method of defining the security condition of a computer system

(76) Inventors: George S. Gales, Plano, TX (US); Craig D. Anderson, Chapel Hill, NC (US); Richard L. Schertz, Raleigh, NC (US); Richard P. Tarquini, Apex, NC (US)

Correspondence Address: HEWLETT-PACKARD COMPANY, Intellectual Property Administration, P.O. Box 272400, Fort Collins, CO, 80527-2400, US

(21) Appl. No.: 10/001,431

(22) Filed: Oct. 31, 2001

(51) Int. Cl. G06F 11/30

(52) U.S. Cl. 713/200

(57) ABSTRACT

The present invention comprises a method of defining security conditions of a computer system. The method comprises the steps of specifying an identity of attack, specifying at least one attribute of the specified attack, and specifying at least one policy definition with respect to the specified attack, specifying at least one attribute of the specified policy definition.

### CROSS-REFERENCE TO RELATED APPLICATIONS

This patent application is related to co-pending U.S. Patent Application, Attorney Docket No. 10014010-1, entitled “METHOD AND COMPUTER READABLE MEDIUM FOR SUPPRESSING EXECUTION OF SIGNATURE FILE DIRECTIVES DURING A NETWORK EXPLOIT”; U.S. Patent Application, Attorney Docket No. 10017028-1, entitled “SYSTEM AND METHOD OF DEFINING THE SECURITY VULNERABILITIES OF A COMPUTER SYSTEM”; U.S. Patent Application, Attorney Docket No. 10017029-1, entitled “SYSTEM AND METHOD OF DEFINING UNAUTHORIZED INTRUSIONS ON A COMPUTER SYSTEM”; U.S. Patent Application, Attorney Docket No. 10017055-1, entitled “NETWORK INTRUSION DETECTION SYSTEM AND METHOD”; U.S. Patent Application, Attorney Docket No. 10016861-1, entitled “NODE, METHOD AND COMPUTER READABLE MEDIUM FOR INSERTING AN INTRUSION PREVENTION SYSTEM INTO A NETWORK STACK”; U.S. Patent Application, Attorney Docket No. 10016862-1, entitled “METHOD, COMPUTER-READABLE MEDIUM, AND NODE FOR DETECTING EXPLOITS BASED ON AN INBOUND SIGNATURE OF THE EXPLOIT AND AN OUTBOUND SIGNATURE IN RESPONSE THERETO”; U.S. Patent Application, Attorney Docket No. 10016591-1, entitled “NETWORK, METHOD AND COMPUTER READABLE MEDIUM FOR DISTRIBUTED SECURITY UPDATES TO SELECT NODES ON A NETWORK”; U.S. Patent Application, Attorney Docket No. 10014006-1, entitled “METHOD, COMPUTER READABLE MEDIUM, AND NODE FOR A THREE-LAYERED INTRUSION PREVENTION SYSTEM FOR DETECTING NETWORK EXPLOITS”; U.S. Patent Application, Attorney Docket No. 10016864-1, entitled “SYSTEM AND METHOD OF AN OS-INTEGRATED INTRUSION DETECTION AND ANTI-VIRUS SYSTEM”; U.S. Patent Application, Attorney Docket No. 10002019-1, entitled “METHOD, NODE AND COMPUTER READABLE MEDIUM FOR IDENTIFYING DATA IN A NETWORK EXPLOIT”; U.S. Patent Application, Attorney Docket No. 10017334-1, entitled “NODE, METHOD AND COMPUTER READABLE MEDIUM FOR OPTIMIZING PERFORMANCE OF SIGNATURE RULE MATCHING IN A NETWORK”; U.S. Patent Application, Attorney Docket No. 10017333-1, entitled “METHOD, NODE AND COMPUTER READABLE MEDIUM FOR PERFORMING MULTIPLE SIGNATURE MATCHING IN AN INTRUSION PREVENTION SYSTEM”; U.S. Patent Application, Attorney Docket No. 10017330-1, entitled “USER INTERFACE FOR PRESENTING DATA FOR AN INTRUSION PROTECTION SYSTEM”; U.S. Patent Application, Attorney Docket No. 10017270-1, entitled “NODE AND MOBILE DEVICE FOR A MOBILE TELECOMMUNICATIONS NETWORK PROVIDING INTRUSION DETECTION”; U.S. Patent Application, Attorney Docket No. 10017331-1, entitled “METHOD AND COMPUTER-READABLE MEDIUM FOR INTEGRATING A DECODE ENGINE WITH AN INTRUSION DETECTION SYSTEM”; U.S. Patent Application, Attorney Docket No. 10017328-1, entitled “SYSTEM AND METHOD OF GRAPHICALLY DISPLAYING DATA FOR AN INTRUSION PROTECTION SYSTEM”; and U.S. Patent Application, Attorney Docket No. 10017303-1, entitled “SYSTEM AND METHOD OF GRAPHICALLY CORRELATING DATA FOR AN INTRUSION PROTECTION SYSTEM”.

### TECHNICAL FIELD OF THE INVENTION

The present invention relates generally to the field of computer systems, and more particularly to a system and method of defining the security condition of a computer system.

### BACKGROUND OF THE INVENTION

Computer system security issues have become extremely important as more and more computers are connected to networks and the Internet. Attacks on computer systems have become increasingly sophisticated due to the evolution of new hacker tools. Using these tools, relatively unsophisticated attackers can participate in organized attacks on one or more targeted facilities. Distributed system attacks, such as denial of service attacks, generally target hundreds or thousands of unprotected or compromised Internet nodes.

In response to these more sophisticated attacks, new intrusion protection and detection systems are being developed and deployed to monitor and prevent attempts to intrude into computer networks. These intrusion protection systems typically have some knowledge of known vulnerabilities of the system they are guarding and properties of known intrusion attack tools. This knowledge is typically recorded in product documentation or stored in tables or databases specific to each system or product. However, there is no common or standard format or representation of the knowledge, which makes it difficult for the users or system administrators to access and use the information, as well as for the system developers to update the information.

### SUMMARY OF THE INVENTION

In one embodiment of the present invention, a method of defining security conditions of a computer system according to a predetermined syntax and format comprises the steps of specifying an identity of attack, specifying at least one attribute of the specified attack, and specifying at least one policy definition with respect to the specified attack, specifying at least one attribute of the specified policy definition.

In another embodiment of the present invention, a method of defining vulnerability conditions of a system coupled to a global network according to a predetermined format is provided. The method comprises the steps of specifying a name of an attack associated with a vulnerability of the system, specifying at least one attribute of the specified attack, specifying a policy definition with respect to the specified attack, and specifying at least one attribute of the specified policy definition.

In yet another embodiment of the present invention, a system of defining security conditions of a computer system comprises a vulnerability description file containing a definition of at least one attack and a definition of at least one policy item for the attack. The system also comprises an interpreter operable to parse the attack and policy item definitions in the vulnerability description file and organize the parsed definitions pursuant a predetermined format. The parsed and organized attack and policy item definitions are stored in a data storage for access by one or more security applications.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified block diagram of a typical distributed attack on a computer system;

FIG. 2 is a block diagram of a computer system deploying network-based, host-based and inline intrusion protection systems within which the present invention may be implemented;

FIG. 3 is a simplified block and data flow diagram of an embodiment of a vulnerability description system according to the teachings of the present invention; and

FIG. 4 is a database diagram of an embodiment of a vulnerability description database storing information from a vulnerability description file of the present invention.

### DETAILED DESCRIPTION OF THE DRAWINGS

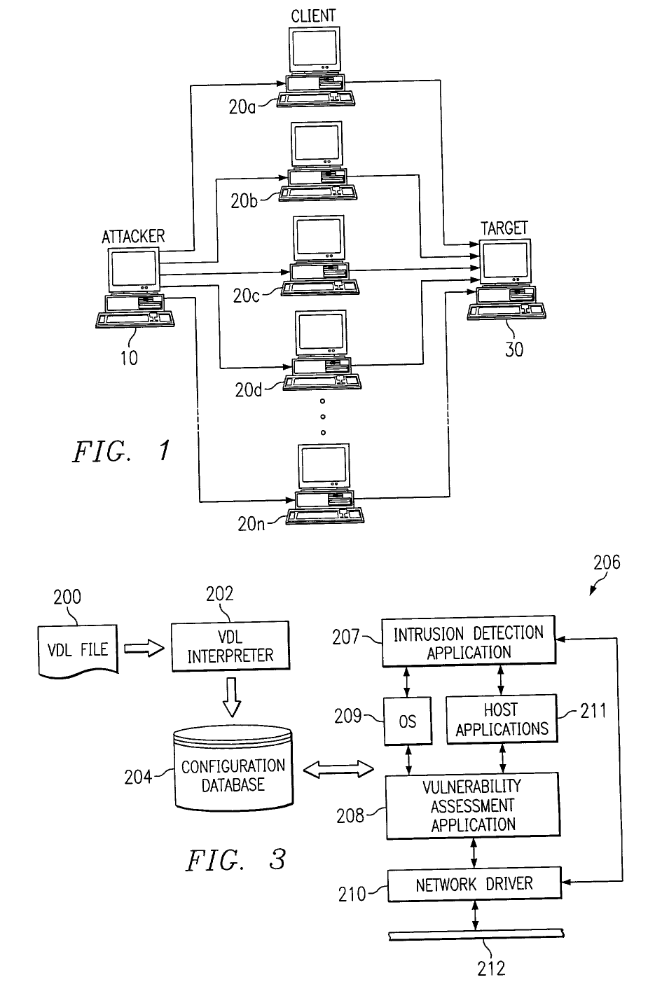

The preferred embodiment of the present invention and its advantages are best understood by referring to FIGS. 1 through 4 of the drawings, like numerals being used for like and corresponding parts of the various drawings.

FIG. 1 is a simplified arrangement common in distributed system attacks on a target 30 machine. An attacker machine 10 may direct execution of a distributed attack by any number of attacker client machines 20a-20n by any number of techniques such as remote control by “robot” applications. Client machines, also referred to as “zombies” and “attack agents” 20a-20n, are generally computers that are accessible by the public via the Internet or otherwise compromised in some manner. Client machines 20a-20n may be geographically distributed. A distributed attack may be launched from client machines 20a-20n by a command issued on attacker machine 10. Numerous types of distributed attacks may be launched against a target machine 30 such as denial of service attacks. The target machine 30 may become so overloaded from the attacks that it can no longer service and respond to legitimate requests.

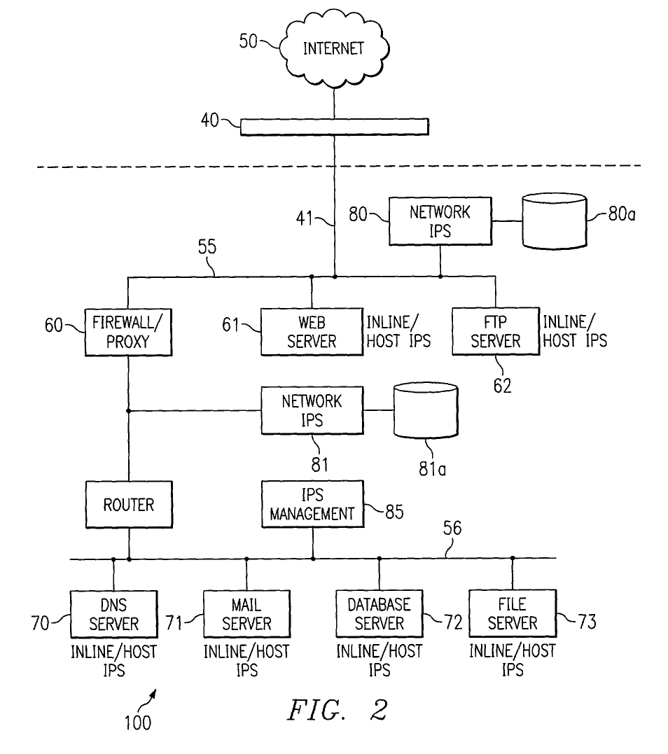

FIG. 2 is a diagram of an embodiment of a comprehensive intrusion protection system (IPS) employing network-based, host-based and inline intrusion protection systems, such as Hewlett-Packard Company's AttackDefender. Network-based intrusion protection systems are generally deployed at or near the entry point or even boundary of a network, such as a firewall. Network-based intrusion protection systems analyze data inbound from the Internet and collect network packets to compare against a database of various known attack signatures or bit patterns. An alert may be generated and transmitted to a management system that may perform a corrective action such as closing communications on a port of the firewall to prevent delivery of the identified packets into the network. Network-based intrusion protection systems generally provide real-time, or near real-time, detection of attacks. Thus, protective actions may be executed before the targeted system is damaged. Furthermore, network-based intrusion protection systems are particularly effective when implemented on slow communication links such as ISDN or T1 Internet connections. Moreover, network-based intrusion protection systems are easy to deploy.

Host-based intrusion protection systems, also referred to as “log watchers,” typically detect intrusions by monitoring system logs. Generally, host-based intrusion systems reside on the system to be protected. Host-based intrusion protection systems generally generate fewer “false-positives,” or incorrect diagnoses of an attack, than network-based intrusion protection systems. Additionally, host-based intrusion protection systems may detect intrusions at the application level, such as analysis of database engine access attempts and changes to system configurations. Log-watching host-based intrusion protection systems generally cannot detect intrusions before the intrusion has taken place and thereby provide little assistance in preventing attacks. Log-watching host-based intrusion protection systems are not typically useful in preventing denial of service attacks because these attacks normally affect a system at the network interface card driver level. Furthermore, because log-watching host-based intrusion protection systems are designed to protect a particular host, many types of network-based attacks may not be detected because of its inability to monitor network traffic. A host-based intrusion protection system may be improved by employing operating system application program interface hooks to prevent intrusion attempts.

Inline intrusion protection systems comprise embedded intrusion protection capabilities into the protocol stack of the system being protected. Accordingly, all traffic received by and originating from the system will be monitored by the inline intrusion protection system. Inline intrusion protection systems overcome many of the inherent deficiencies of network-based intrusion protection systems. For example, inline intrusion protection systems are effective for monitoring traffic on high-speed networks. Inline intrusion protection systems are often more reliable than network-based intrusion protection systems because all traffic destined for a server having an inline intrusion protection system will pass through the intrusion protection layer of the protocol stack. Additionally, an attack may be prevented because an inline intrusion protection system may discard data identified as associated with an attack rather than pass the data to the application layer for processing. Moreover, an inline intrusion protection system may be effective in preventing attacks occurring on encrypted network links because inline intrusion protection systems may be embedded in the protocol stack at a layer where the data has been decrypted. Inline intrusion protection systems is also useful in detecting and eliminating a device from being used as an attack client in a distributed attack because outbound, as well as inbound, data is monitored thereby.

Referring to FIG. 2, one or more networks 100 may interface with the Internet 50 via a router 40 or another suitable device. In network 100, for example, two Ethernet networks 55 and 56 are coupled to the Internet 50 via router 40. Ethernet network 55 comprises a firewall/proxy server 60 coupled to a web-content server 61 and a file transport protocol content server 62. Ethernet network 56 comprises a domain name server (DNS) 70 coupled to a mail server 71, a database sever 72, and a file server 73. Network-based intrusion protection systems deployed on dedicated appliances 80 and 81 are disposed on two sides of firewall/proxy server 60 to facilitate monitoring of attempted attacks against one or more nodes of network 100 and to facilitate recording successful attacks that successfully penetrate firewall/proxy server 60. Network intrusion protection devices 80 and 81 may respectively comprise (or alternatively be connected to) databases 80a and 81a containing known attack signatures. Accordingly, network intrusion protection device 80 may monitor all packets inbound from Internet 50. Similarly, network intrusion protection device 81 monitors and compares all packets that passed by firewall/proxy server 60 for delivery to Ethernet network 56.

An IPS management node 85 may also be comprised in network 100 to facilitate configuration and management of the intrusion protection system components comprised in network 100. In view of the deficiencies of host-based and network-based intrusion protection systems, inline and/or host-based intrusion protection systems may be implemented within any of the various nodes of Ethernet networks 55 and 56, such as node 85. Additionally, management node 85 may receive alerts from respective nodes within network 100 upon detection of an intrusion event.

Preferably, network intrusion protection devices 80 and 81 are dedicated entities for monitoring network traffic on associated links of network 100. To facilitate intrusion protection in high speed networks, network intrusion protection devices 80 and 81 preferably comprise a large capture RAM (random access memory) for capturing packets as they arrive on respective Ethernet networks 55 and 56. Additionally, it is preferable that network intrusion protection devices 80 and 81 respectively comprise hardware-based filters for filtering high-speed network traffic. Filters may be alternatively implemented in software at a potential loss of speed and corresponding potential losses in protective abilities provided thereby to network 100. Moreover, network intrusion protection devices 80 and 81 may be configured, for example by demand of IPS management node 85, to monitor one or more specific devices rather than all devices on a network. For example, network intrusion protection device 80 may be instructed to monitor only network data traffic addressed to web server 61. Hybrid host-based and inline-based intrusion protection system technologies may be implemented on all other servers on Ethernet networks 55 and 56 that may be targeted in a distributed system attack. A distributed intrusion protection system such as the one described above may be implemented on any number of platforms, such as UNIX, Windows NT, Windows, Linux, etc.

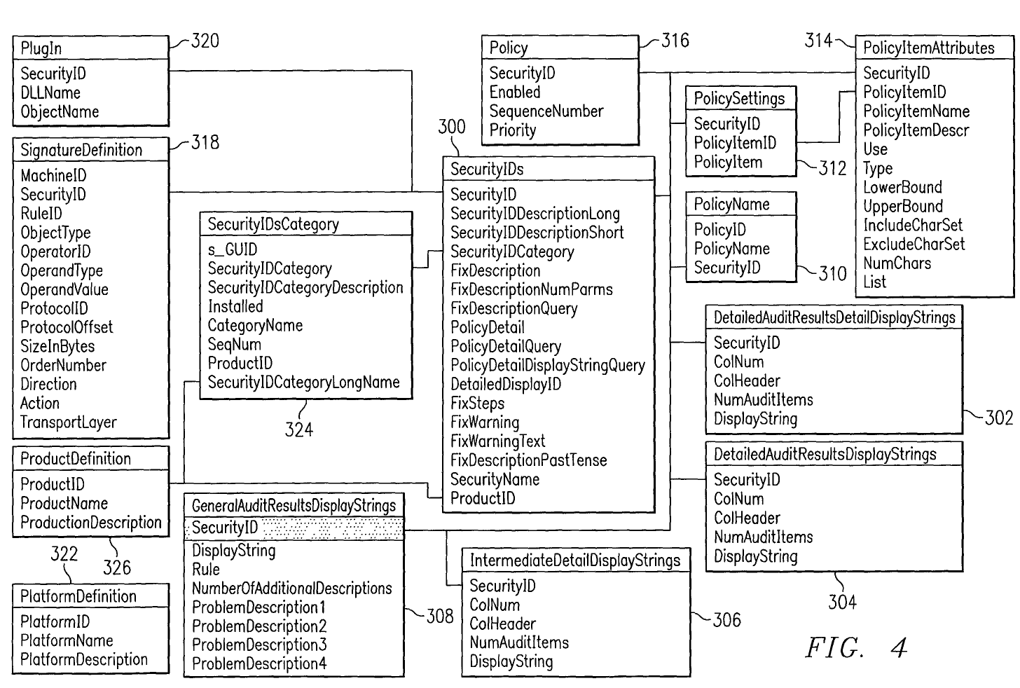

FIG. 3 is a simplified data flow diagram of an embodiment of the present invention. A vulnerability description language (VDL) file 200 is preferably a text file having a standard format that specifies security and/or vulnerability descriptions of one or more computer systems. VDL file 200 comprises a collection of hierarchical security specifications, which are defined by product, category, and group definitions. For example, VDL file 200 may comprise these levels of definition (with the security definition details removed):

```
BEGIN_SECURITY_PRODUCT: IntruderDetect
  BEGIN_SECURITY_CATEGORY: TROJANS
    BEGIN_POLICY_GROUP: “\Intrusion Detection Policy\Trojan Horses\TCP-Based”
      BEGIN_SECURITY_DEF: HackOffice
              ...
      END_SECURITY_DEF
      BEGIN_SECURITY_DEF: SubSeven
              ...
      END_SECURITY_DEF
    END_POLICY_GROUP
    BEGIN_POLICY_GROUP: “\Intrusion Detection Policy\Trojan Horses\UDP-Based”
      BEGIN_SECURITY_DEF: BackOrifice
              ...
      END_SECURITY_DEF
    END_POLICY_GROUP
  END_SECURITY_CATEGORY
END_SECURITY_PRODUCT
```

Further details of the VDL format are set forth below. VDL file 200 may describe the vulnerability of a computer system, how to test for its presence, how to report the detection of a vulnerability, and how to repair the vulnerability. For example, a computer system may have a vulnerability of allowing network peers to assist in managing NetBios name conflicts with an unauthenticated protocol that is subject to spoofing. When used by a network intrusion detection system or network protection system, VDL file 200 preferably comprises a description of attack data signatures. Attack signatures are patterns in the transmitted data or network frames that are indicative of an attack such as the ping of death.

VDL file 200 may be read and compiled by a VDL interpreter 202, which parses the descriptions therein and organizes them into one or more tables in a configuration database 204. Alternatively, an application program may compile or interpret VDL file 200 upon start up or on-the-fly and store the security definition information in memory. An example of how configuration database 204 may be organized is shown in FIG. 4, described in more detail below. VDL interpreter 202 may organize the data in configuration database 204 according to a format and layout specified by a maker of application programs 206 that use its data, such as intrusion detection applications 207 and vulnerability assessment applications 208. Intrusion detection applications 207 and vulnerability assessment applications 208 monitor network data received by a network driver 210 from a network 212 according to the security definitions stored in configuration database 204. Applications 207 and 208 may also interface with host operating system 209 and host applications 211.

There are four groups of information in the security definitions set forth in VDL file 200. The first group comprises descriptions of a security condition, such as a vulnerability or an attack, and how to repair or prevent it. These standard description format strings comprise PLATFORM, SEVERITY, DESCRIPTION, BRIEF_DESCRIPTION, EXPLANATION, AUTO_FIX_DESCRIPTION, and MANUAL_FIX_DESCRIPTION. In VDL, there is also a concept of platforms. A security definition, as well as its policy items, can be defined for one or more platforms. Preferably, when the security product is running on a specific platform, only security definitions assigned to that particular platform are enforced, and only policy items assigned to that particular platform are presented or reported to the user. Alternatively, a network administrator may prefer to receive reports regarding multiple platforms or nodes in the network. The platform definition typically describes the type of system the security product application is running on, such as a black box appliance, an agent running on a server, etc. The actual text displayed to the user or administrator of the security product is stored within the VDL, making translation a fairly simple issue. This text is used both in the user interface as well as on printed reports.

The second group of security definitions comprises strings describing how audit or detection results are to be presented. These standard vulnerability description strings may comprise, for example, GENERAL_RESULTS_TEXT, BEGIN_INTERMEDIATE_RESULTS_TEXT_DEF, END_INTERMEDIATE_RESULTS_TEXT_DEF, and BEGIN_DETAILED_RESULTS_TEXT_DEF END_DETAILED_RESULTS_TEXT_DEF. VDL preferably provides a three-tiered results reporting model: general results, intermediate results, and detailed results. General results are summary-level and single-line strings. Intermediate and detailed results are usually presented in a tabular format, with the columns defined in the VDL. Results are usually presented in the application's user interface as well as in reports. It is up to the security product application to determine which level of reporting is desired for which particular situation.

The third group of security definitions comprises one or more BEGIN_POLICY_DEF and END_POLICY_DEF sections, which provide policy settings for a vulnerability or intrusion. Policy items are user-configurable parameters for the particular vulnerability or intrusion. Usually the policy items define how the vulnerability or intrusion is detected, reported or repaired.

The fourth group of security definitions comprises definitions that specify how an intrusion is to be detected. This group may comprise zero or more BEGIN_SIGNATURE_DEF and END_SIGNATURE_DEF sections. The data frame bit or byte pattern indicative of a known attack is defined in this section. For example, the signature definition for a typical ping of death distributed attack may be defined by:

if ((icmp) && (65535<((ip[2:2]−((ip[0:1]& 0x0f)*4))+((ip[:2]& 0x1fff)*8)))))

Optionally, a PLUGIN keyword may be used to delegate the detection task to another application module. The PLUGIN keyword provides the name of a DLL (dynamically linked library) or object that will handle recognition of the intrusion. The DLL is passed all packets matching the SIGNATURE_DEF sections.

Hereinafter is a more detailed description of VDL standard format for describing computer system vulnerability. Heretofore, vulnerability or intrusion information of computer systems are typically contained in Read Me files, user documentation, databases or other locales in non-standard formats. These files or manuals are typically only readable by humans. The VDL descriptions in the VDL files of the present invention may be read by humans as well as computer programs because it provides a standard syntax and format. In the description below, text within angled brackets are explanations or descriptions that are not taken literally, text not within angled brackets should be taken literally, and keywords in all caps are mandatory unless specifically labeled as optional. The following shows the general structure and format of a VDL file according to the teachings of the present invention:

```
BEGIN_SECURITY_PRODUCT: <product name>
BEGIN_POLICY_GROUP: <policy folder name>
  BEGIN_POLICY_DEF: <policy item name>
    <policy properties>
    ...
  END_POLICY_DEF
END_POLICY_GROUP
...
BEGIN_SECURITY_CATEGORY: <category name>
BEGIN_POLICY_GROUP: <policy folder name>
  BEGIN_POLICY_DEF: <policy item name>
    <policy properties>
    ...
  END_POLICY_DEF
  BEGIN_SECURITY_DEF: <security item name>
    <security item properties>
    ...
    BEGIN_POLICY_DEF: <policy item name>
      <policy properties>
      ...
    END_POLICY_DEF
    BEGIN_SIGNATURE_DEF: <policy item name>
      <if statements>
      ...
    END_SIGNATURE_DEF
  END_SECURITY_DEF
  ...
END_POLICY_GROUP
END_SECURITY_CATEGORY
...
END_SECURITY_PRODUCT
```

The product definition section encapsulates all other sections related to a product. A VDL file can contain multiple product definition sections. A product definition section is used to specify the name of a security product such as an intrusion detection application, intrusion protection application, or vulnerability scanner. The preferred format for product definition is:

```
BEGIN_SECURITY_PRODUCT: <product name>
  <Policy Group Definition sections>
  <Category Definition sections>
END_SECURITY_PRODUCT
```

The product definition section is delineated by the BEGIN_SECURITY_PRODUCT keyword and a matching END_SECURITY_PRODUCT keyword. The section can contain multiple policy group definition sections and multiple category definition sections.

The policy group definition section associates a group of policy item definitions or security item definitions with a policy folder. One or more policy group definition sections can appear within a product definition section or a category definition section. The preferred format is:

```
BEGIN_POLICY_GROUP: <policy folder name>
  <Policy Item Definition sections>
  <Security Item Definition sections>
END_POLICY_GROUP
```

The policy folder name specifies the full name of the folder that contains the encapsulated policy items and security items. An example is:

BEGIN_POLICY_GROUP: “\My Policy\My Policy Items”

In this example all encapsulated policy items or security items will be placed in the “My Policy Items” subfolder within the “My Policy” parent folder.

The category definition section associates a group of related security items and policy items. One or more category definition sections can appear within a product definition section. A category definition section can contain one or more policy group definition sections. The preferred format according to the present invention is:

BEGIN_SECURITY_CATEGORY: <category name>
<Policy Group Definition sections>
END_SECURITY_CATEGORY

The policy item definition section is used to describe all properties related to a policy item. Policy items typically correspond to parameters that are required to perform an audit or to detect an intrusion. However, there are many policy items that provide generic settings such as schedule configuration and e-mail configuration. Policy items typically have default values, which may be revised by the user. The data for a policy item is stored in a database. The user's policy consists of the entire collection of policy items in the database.

BEGIN_POLICY_DEF: <policy item name>

| | |
|---|---|
| <platform> | // Optional. Default is ALL |

```
  <policy item brief description>
  <policy item explanation>
  <type>
  <default value>
```

| | |
|---|---|
| <lower bound> | // Optional. Valid only if <type> = NUMBER |
| <upper bound> | // Optional. Valid only if <type> = NUMBER |
| <num chars> | // Optional. Default is 256 |
| <exclude char set> | // Optional. Mutually exclusive with |
| | <include char set> |
| <include char set> | // Optional. Mutually exclusive with |
| | <exclude char set> |
| <list> | // Mandatory if <type> = DROPLIST |
| <prog id> | // Mandatory if <type> = CUSTOM |
| <fix only flag> | // Optional |

END_POLICY_DEF

The <policy item name> specifies the name of the policy item. The name format preferably does not allow white space characters (i.e. blanks or tabs). The <platform> specifies the computer platform that applies to the policy/security item. Exemplary platforms may comprise AGENT, APPLIANCE, MOBILE, AGENT_AND_APPLIANCE, or ALL (default). The platform specification may not be mandatory. The <policy item explanation> contains text that describes the policy item and may be used in reports and/or on screen help dialog windows. The <policy item explanation> may contain a few sentences that describe the policy item. This description may be used in reports and may also be used to provide additional onscreen help. The <type> field specifies the type of policy item, which may specify CHAR, NUMBER, DROPLIST, CHECKBOX, or CUSTOM types. The CHAR type indicates that the policy item requires an edit field, the NUMBER type indicates that the policy item requires an edit field for numerals, the DROPLIST type indicates that the policy item requires a dropdown list of items, the CHECKBOX indicates that the policy item requires a checkbox, and the CUSTOM type indicates that the policy item requires a custom dialog box to retrieve input from the user. The <default value> field specifies the default value associated with the policy item. The default value format is as a string surrounded by double quotes. The <lower bound> specification is valid only when <type> is NUMBER and specifies the lower bound for the range of valid numbers associated with the policy item. Preferably, the user will not be allowed to enter numbers less than <lower bound>. If<lower bound> is specified then <upper bound> should also be specified. Similarly, the user will not be allowed to enter numbers greater than <upper bound>. The <num chars> specifies the maximum number of characters allowed in the edit box associated with a policy item. The <exclude char set> specifies characters that are not allowed in the edit box associated with a policy item. The <include char set> specifies characters that are allowed in the edit box associated with a policy item. The <list> field specifies items to be contained in the dropdown listbox. The <prog id> specifies the Prog ID of a COM object that can display a dialog box used to retrieve the custom policy data when <type> is CUSTOM. The <fix only flag> is used to indicate that the policy item is for fixing a security problem and not auditing it. If this flag is not set then the policy item is for fixing a security problem as well as auditing it.

The security item definition section preferably describes all properties related to a security item. Security items typically are the subject matter being audited or detected. For example, a security item may be the ping of death attack to be detected, or ReleaseNetBiosName vulnerability to be audited.

| BEGIN_SECURITY_DEF: <security item name> | |
|---|---|
| <platform> | // Optional. Default is ALL |
| <security item explanation> | |
| <security item brief description> | |
| <severity> | |
| <autofix description> | |
| <autofix past tense description> | |
| <autofix warning> | |
| <manual fix description> | |
| <fix description query> | |
| <general results text> | |
| <detailed display option> | |
| <enabled> | // Optional. Default is 1 (enabled) |

| | |
|---|---|
| <Detailed Results Text Definition section> | // Optional. |
| <Intermediate Results Text Definition section> | // Optional |
| <Policy Item Definition section> | // Optional |
| <Signature Definition section> | // Optional |
| <Plugin> | // Optional |
| <Auditor> | // Optional |

END_SECURITY_DEF

The <security item name> specifies the name of the security item and preferably does not contain white spaces. The <security item brief description> is preferably a mandatory field and specifies text that is displayed in an editor that a user may use to edit or revise the policy item data. This editor may be a dedicated policy editor that is a component of a graphical user interface. The text should briefly describe the security check to be performed. For example, BRIEF_DESCRIPTION: “Check administrator account name”. The <security item explanation> field is used to specify text that explains why the specified security item is an issue and how hackers can exploit the vulnerability to damage the system, for example. The <severity> field specifies the severity of a potential vulnerability or attack on a predetermined scale, such as 1 to 5. The <autofix description> contains a brief description of what will be fixed by an autofix feature of a vulnerability assessment system, such as the INTELLIFIX feature of the SFPROTECT system. This description can contain one or more string format specifiers such as %s. Whenever the system encounters a % in the <autofix description> it will replace it with the parameter returned from the <fix description query>. Preferably, the order of the parameters returned by the query will be the order in which they are inserted in the <autofix description> string. The <autofix past tense description> field contains a brief description of what has been fixed by the autofix feature. This description can contain one or more string format specifiers (i.e. % s). Whenever the system encounters a % in the <autofix past tense description> it will preferably replace it with the parameter returned from the <fix description query>. The order of the parameters returned by the query will be preferably the order in which they are inserted in the <autofix past tense description> string. For example, the <autofix past tense description> field may specify “Fix has changed the administrator account name to “% s”.” The <autofix warning> is used to contain a brief warning to the users to remind them of the consequences of performing an automatic remedy to the specified security item. For example, AUTO_FIX_WARNING: “Record the new name of the administrator account and be sure to communicate the new name to the other administrators.” If the security item can be fixed, this field is preferably mandatory. The <fix description query> field specifies a query used to format an autofix description string. For example, FIX_DESCRIPTION_QUERY: “SELECT PolicySettings.PolicyItem FROM PolicySettings WHERE (((PolicySettings.SecurityID)=1000))” applies to: <autofix description> and <autofix past tense description>.

The <manual fix description> field is used to specify a step-by-step description of how to manually fix the security problem. For example, MANUAL_FIX_DESCRIPTION: “If Internet Information Server has been installed on the Operating System volume, it will have to be uninstalled and reinstalled on an alternate volume. If a virtual directory has been set up on the Operating System volume, use the Microsoft Management Console to drop and then create a new virtual directory on an alternate volume. For more information about virtual directories, see the Product Documentation for the Windows NT 4.0 Option Pack.” This field is also preferably mandatory. The <general results text> field contains a string to be displayed in the general results window. For a vulnerability scanner, it should specify the results of a security audit; for an intrusion protection system, it should contain a general description of the attack that was detected. For example, “% s of % s files or subdirectories have failed the permissions check.” may be used as the <general results text> string for security item used to check file permissions. This allows the user to be informed of the status of the audit. The <detailed display option> field preferably specifies one of three levels of detailed display to be used by the security item, including no detailed display, normal level of details, and optimized detailed display. The <enabled> field specifies whether or not the security item is initially checked in the policy editor. Security items are enabled by default. The <plugin> field specifies name of a security plug-in to associate with a security item. A plugin is an object which can be dynamically loaded into the system. The plugin name has the format: DLLName.ObjectName.

The signature definition section contains expressions describing the tell tale data pattern of a network-based attack. One or more <if statements> can be used to describe an attack signature. The signature definition section can only exist within a security item definition section. There can only be one signature definition section per security item definition section. The general format and syntax of the signature definition section is:

```
BEGIN_SIGNATURE_DEF
  <if>
  <signature expression>
  DIRECTION: INBOUND
  <endif>
END_SIGNATURE_DEF
```

Each security definition can have multiple signature expressions:

```
BEGIN_SIGNATURE_DEF
  <if>
  <signature expression>
  DIRECTION: INBOUND
  <endif>
  <if>
  <signature expression>
  DIRECTION: INBOUND
  <endif>
  <if>
  <signature expression>
  DIRECTION: OUTBOUND
  <endif>
END_SIGNATURE_DEF
```

An example is shown below:

```
BEGIN_SIGNATURE_DEF
  if ( (udp) && (ip[19:1] =0 ∥ ip[19:1] = 0xff) &&
    (udp[2:2] =7 ∥ udp[2:2] =17 ∥ udp[2:2] = 19)) then
      ACTION: LOG_FRAME
      DIRECTION: INBOUND
  Endif
END_SIGNATURE_DEF
```

The <signature expression> field describes the condition(s) for detecting a network-based attack. The signature expression can span multiple lines and must have the following general syntax:

```
If <if expression> then
  ACTION: <action>
  DIRECTION: <direction>
endif
```

or <signature expression> may be <if expression> [symbol] (<if expression>)|(<operand> <operator₂> <operand>), or <if expression> [symbol] (<if expression>)|(<operand><operator₁>), where <operator₁> is a unary operator and <operator₂> is a binary operator. Possible unary operators comprise bitwise complement and NOT. Possible binary operators comprise logical, arithmetic, and bitwise operations. <operand> is expressed by <protocol expression>|<literal number> <policy variable>, where <protocol expression> is <protocol>{[offset: byte length]}. <protocol> may comprise TCP, ICMP, UDP, IP, MAC, IGMP, GCP, PUP, RAW, and other protocols. The field <literal number> comprises any “C” style numeric expression, such as 0xfffff, 100. The <policy variable> field comprises $: <policy item name>. The <action> field specifies the action to be taken when the signature expression evaluates to true. The <action> field may specify LOG_FRAME (log frame each time the signature expression evaluates to true) and/or INCREMENT_COUNTER (a counter will be incremented each time the signature expression evaluates to true). The <direction> field specifies the direction to apply the signature expression to indicate whether the data flow is INBOUND and/or OUTBOUND.

The detailed results text definition section is used to specify the formatting of the detailed results table. This information is used by a DetailedResultsGrid control to determine how to format the data for the detailed results view. The general format is:

```
BEGIN_DETAILED_RESULTS_TEXT_DEF
  <header cols>
  <celltext_cols>
END_DETAILED_RESULTS_TEXT_DEF
```

The intermediate results text definition section preferably specifies the formatting of the intermediate results table. This information is used by the DetailedResultsGrid control to determine how to format the data for the intermediate results view. A general format is:

```
BEGIN_INTERMEDIATE_RESULTS_TEXT_DEF
  <header cols>
  <celltext_cols>
END_INTERMEDIATE_RESULTS_TEXT_DEF
```

The <header cols> field is used to specify the text for column header of a display table. For example, the following <header col> fields specify the text to be displayed in the first and second column headers of the detailed display table. In this example, the column header for the first column would be displayed as “User Name”. The second column header would be displayed as “Last Logon”.

```
BEGIN_DETAILED_RESULTS_TEXT_DEF
  HEADER_COL1:“User Name”
  CELLTEXT_COL1:“%s”
  HEADER_COL2:“Last Logon”
  CELLTEXT_COL2:“%s”
END_DETAILED_RESULTS_TEXT_DEF
```

This would result in:

| User Name | Last Logon |
|---|---|
| Fred | Jul. 1, 1999 |
| John | Jun. 24, 1999 |
| Jim | Jul. 9, 1999 |

The <celltext_cols> field specifies the text to be used in each cell of a display table. The string can contain string format specifiers (i.e. % s). If<detailed display option> is NORMAL display, the display string will come from the AuditObject fields of from a joined query of the DetailedAuditResults table and the DetailedAuditResultsDetail table. If<detailed display option> is OPTIMIZED display, the CELLTEXT_COL field is ignored. The information to be displayed is written directly into the AuditObject field in the DetailedAuditResults table. The tab characters in the AuditObject field are used as delimiters for placing text in the proper column.

The VDL file, the syntax and format of which is set forth in detail above, is preferably read and parsed to organize the vulnerability information specified therein into a form that can be accessed and used by security applications such as vulnerability scanners, intrusion detection systems and intrusion protections systems. FIG. 4 is an exemplary relational database diagram of a vulnerability database that may be used to store the data obtained and parsed from VDL file 200 (FIG. 3). Recall from the foregoing that the VDL file preferably contains four types of specification:

1) specification of the vulnerability and attack, and how to prevent or repair it

2) specification of how the audit or detection results should be presented or reported

3) specification of what policy or settings govern a particular vulnerability or intrusion

4) specification of how to recognize an intrusion

The category 1 information supplied in the VDL file are stored in a security definitions table 300. Each security item is assigned a unique security identifier (SecurityID) which is used to index and link the information in several other tables in the database to security definitions table 300. There is typically a one-to-one correspondence from a security item specification in the VDL file to a data field in security definitions table 300. Information from category 2 on how results should be presented and displayed are stored in several tables, including DetailedAuditResultsDetailDisplayStrings table 302, DetailedAuditResultsDisplayStrings table 304, IntermediateDetailDisplayStrings table 306, and GeneralAuditResultsDisplayStrings table 308. Information from category 3 on policy settings are stored in several tables, including PolicyName table 310, PolicySettings table 312, PolicyltemAttributes table 314, and Policy table 316. It may be seen that each policy item is assigned a policy item identifier, which is used to link PolicyltemAttributes table 314 to PolicySettings table 312. All policy setting tables 310-316 are also linked to security definitions table 300 by SecurityID. Information in category 4 is stored in SignatureDefinitions table 318 and PlugIn table 320, both of which are preferably linked to security definitions table by SecurityID. A PlatformDefinition table 322 is further used to store the computer platform information identified in the security item definition description of the VDL. Furthermore, information related to the security product specification is stored in SecurityIDsCategory table 324 and ProductDefinition table 326. Tables 324 and 326 are indexed and linked to security definitions table 300 via the SecurityIDCategory data entry and an identifier, ProductID, assigned to the security product.

The vulnerability information stored in the database is accessible by an number of security product applications, such as intrusion detection systems and vulnerability scanners. A graphical user interface may be used to facilitate entry of vulnerability data in the VDL file and also to provide on-screen reporting of detection and audit results according to the information specified in the VDL file.

According to the present invention, a standard text-based syntax and format for describing a computer system's security condition is used so that users may easily view and update and modify the description to adapt to changing conditions. Furthermore, because of the standard syntax, computer applications may be developed to read and process the information in the vulnerability description file, such as parsing the data to store into a relational database or to store the data in memory during application execution. The standard syntax and format of the present invention enables uniformity and inter-operability between various applications.

what is claimed is:

1. A method of defining the security condition of a computer system, comprising:
specifying an identity of an attack;
specifying at least one attribute of the specified attack;
specifying at least one policy definition with respect to the specified attack; and
specifying at least one attribute of the specified policy definition.

2. The method, as set forth in claim 1, further comprising:
specifying a computing platform of the computer system; and
specifying a data signature of the specified attack on the computing platform.

3. The method, as set forth in claim 1, further comprising:
specifying a security category of the specified attack; and
specifying at least one policy group with respect to the specified security category.

4. The method, as set forth in claim 1, further comprising specifying a security product executing on the computer system.

5. The method, as set forth in claim 1, wherein specifying at least one attribute of the specified attack comprises specifying an identification of the severity associated with a breach of the computer system by the specified attack.

6. The method, as set forth in claim 1, wherein specifying at least one attribute of the specified attack comprises specifying a description of the attack.

7. The method, as set forth in claim 1, wherein specifying at least one attribute of the specified attack comprises specifying an explanation of why the specified attack is important.

8. The method, as set forth in claim 1, wherein specifying at least one attribute of the specified attack comprises specifying how information is to be reported to a user with respect to the specified attack.

9. The method, as set forth in claim 1, wherein specifying at least one attribute of the specified attack comprises specifying an application operable to respond to a breach of the computer system by the specified attack.

10. The method, as set forth in claim 1, wherein specifying a signature of the specified attack comprises:
specifying a network protocol;
specifying a data pattern; and
specifying an action in response to detecting the specified network protocol and data pattern.

11. The method, as set forth in claim 1, wherein specifying a signature of the specified attack comprises specifying a direction of data flow.

12. A method of defining vulnerability conditions of a system coupled to a global network, comprising:
specifying a name of an attack associated with a vulnerability of the system;
specifying at least one attribute of the specified attack, and the severity of the specified attack associated with a breach of the computer system by the specified attack;
specifying a policy definition with respect to the specified attack;
specifying at least one attribute of the specified policy definition;
specifying a computing platform of the system.

13. The method, as set forth in claim 12, further comprising:
specifying a security category of the specified attack; and
specifying at least one policy group with respect to the specified security category.

14. The method, as set forth in claim 12, wherein specifying at least one attribute of the specified attack comprises specifying how information is to be reported to a user with respect to the specified attack.

15. The method, as set forth in claim 12, wherein specifying at least one attribute of the specified attack comprises specifying an application operable to respond to a breach of the computer system by the specified attack.

16. The method, as set forth in claim 12, wherein specifying at least one attribute of the specified attack comprises specifying a source of an application operable to repair the vulnerability.

17. A system of defining security conditions of a computer system, comprising:
a vulnerability description file containing a definition of at least one attack and a definition of at least one policy item for the attack;
an interpreter operable to parse the at least one attack and at least one policy item definition in the vulnerability description file and organize the parsed definitions pursuant to a predetermined format; and
a data storage operable to store the parsed and organized at least one attack and at least one policy item definition, wherein the data storage is accessible by at least one security application.

18. The system, as set forth in claim 17, wherein the data storage is a relational database having a plurality of tables.

19. The system, as set forth in claim 17, wherein the data storage is a memory.

20. The system, as set forth in claim 17, wherein the vulnerability description file further comprises a definition of a security product.

21. The system, as set forth in claim 17, wherein the vulnerability description file further comprises a definition of a security category providing a grouping of the at least one attack, and a definition of a policy group providing a grouping of the at least one policy item.

22. The system, as set forth in claim 17, wherein the vulnerability description file further comprises a definition of a computing platform.

23. The system, as set forth in claim 17, wherein the vulnerability description file further comprises a definition of at least one attribute of the at least one attack.

24. The system, as set forth in claim 17, wherein the vulnerability description file further comprises an identification of the severity associated with a breach of the computer system by the at least one attack.

25. The system, as set forth in claim 17, wherein the vulnerability description file further comprises a description of the at least one attack.

26. The system, as set forth in claim 17, wherein the vulnerability description file further comprises a definition of how information are to be displayed and reported to the user in response to generated results with respect to the at least one attack.

27. The system, as set forth in claim 17, wherein the vulnerability description file further comprises a definition of an application operable to respond to a breach of the computer system by the at least one attack.

28. The system, as set forth in claim 17, wherein the vulnerability description file further comprises a signature of the specified attack having:
a network protocol;
a data pattern; and
an action in response to detecting the specified network protocol and data pattern.

29. The system, as set forth in claim 17, wherein the vulnerability description file further comprises a signature of the specified attack having a direction of data flow.
